(19) United States
(12) Patent Application Publication
(10) Pub. No.: US 2008/0241364 A1
(43) Pub. Date: Oct. 2, 2008

(54) CONDUCTIVE METAL PASTE AND METHOD OF FORMING METAL FILM

(76) Inventor: Katsuhiro Sato, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/053,882

(22) Filed: Mar. 24, 2008

(30) Foreign Application Priority Data
Mar. 26, 2007 (JP) 2007-080135

(51) Int. Cl. H01B 1/22; B05D 5/12

(52) U.S. Cl. 427/123; 252/512

(57) ABSTRACT

A conductive metal paste contains metal particles dispersed as a conductive medium in a thermosetting resin composition, an organic solvent, and a reducing agent of an alcohol having one or more reductive hydroxyl groups in the molecule and having a boiling point of 200° C. or lower.

### CROSS-REFERENCE TO RELATED APPLICATIONS

This application is based upon and claims the benefit of priority from prior Japanese Patent Application No. 2007-080135, filed Mar. 26, 2007, the entire contents of which are incorporated herein by reference.

### BACKGROUND OF THE INVENTION

1. Field of the Invention

The present invention relates to a conductive metal paste containing a reducing agent and a method of forming a metal film.

2. Description of the Related Art

Electrodes, wiring and others in electronic devices are generally prepared by forming a conductive film by a vacuum film-forming method such as vacuum deposition, sputtering or CVD and processing the conductive film by photolithography and etching. However, film forming by the vacuum film-forming method demands an extended period of time for film formation and thus, results in lower throughput. In addition, film-forming apparatuses using such vacuum film-forming method are expensive, leading to increase in the cost for film formation and for the production facility.

For this reason, a coating method of forming a film by coating conductive metal paste on electronic devices is practiced as a low-cost conductive film-forming method, replacing the vacuum film-forming method. The coating method, including a printing method, is higher in throughput than the vacuum film-forming method and allows formation of a conductive film in a shorter period of time. Such a coating method uses a film-forming apparatus cheaper than that for the vacuum film-forming method and thus, allows reduction of the production cost.

Metal pastes mainly containing highly conductive silver particles, and those containing cost-effective copper particles are known as the metal pastes for use in formation of a conductive film (see Jpn. Pat. Appln. KOKAI Publication No. 2006-260951).

However, the conductive film-forming method by using the coating method described above had the following problems. Although the production cost may be reduced by the coating method, an oxidized layer is formed by heating on the metal particles contained in the metal paste. Thus, there was a concern about significant increase in volumetric resistivity by the coating method, compared to the vacuum film-forming method.

In addition, metal pastes containing copper particles are higher in volumetric resistivity than those containing silver particles. Thus, there was a problem that the metal film formed with a metal paste containing copper particles by the coating method had a volumetric resistivity significantly higher than that of the metal film formed by the vacuum film-forming method.

### BRIEF SUMMARY OF THE INVENTION

According to an aspect of the present invention, there is provided a conductive metal paste, comprising: metal particles dispersed as a conductive medium in a thermosetting resin composition; an organic solvent contained in the thermosetting resin composition; and an alcoholic reducing agent which is contained in the thermosetting resin composition, has at least one reductive hydroxyl group in a molecule and a boiling point of 200° C. or lower, and reduces oxidized metal particles.

According to another aspect of the present invention, there is provided a conductive metal paste, comprising: metal particles dispersed as a conductive medium in a thermosetting resin composition; an organic solvent contained in the thermosetting resin composition; and anisole contained in the thermosetting resin composition as a reducing agent which reduces oxidized metal particles.

According to yet another aspect of the present invention, there is provided a method of forming a metal film, comprising: coating a conductive metal paste containing metal particles dispersed as a conductive medium in a thermosetting resin composition, an organic solvent contained in the thermosetting resin composition, and a reducing agent contained in the thermosetting resin structure for reduction of oxidized metal particles; and baking the coated conductive metal paste by applying heat at 180° C. or higher and 250° C. or lower into a metal film.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory view schematically showing a method of forming a metal film by using conductive copper paste according to an embodiment of the present invention;

FIG. 2 is a graph showing the relationship between an amount of ethanol as a reducing agent added to the conductive copper paste and average volumetric resistivity;

FIG. 3 is a graph showing the relationship between an amount of ethylene glycol as the reducing agent and the average volumetric resistivity;

FIG. 4 is a graph showing the relationship among each average volumetric resistivity of the respective reducing agents; and

FIG. 5 is an explanatory view schematically showing a modified example of the method of forming a metal film by using the conductive copper paste.

### DETAILED DESCRIPTION OF THE INVENTION

Hereinafter, a conductive metal paste according to an embodiment of the present invention will be described in detail. A conductive copper paste, which uses a copper paste as the metal paste, is used as the conductive metal paste in the present embodiment.

The conductive copper paste is a dispersion solvent prepared by blending a copper paste containing a thermosetting resin as the principal component with a reducing agent and stirring the resulting mixture with a spatula. Accordingly, the copper paste contains a reducing agent uniformly dispersed.

The copper paste for use is, for example, a copper paste manufactured by Daiken Chemical Co., Ltd. The copper paste includes a thermosetting resin containing an organic solvent, as well as spherical copper particles and silver contained therein respectively in amounts of 72 to 83.7 mass % and 8 to 9.3 mass %. The spherical copper particles have a silver-coated surface for prevention of oxidation. The thermosetting resin for use is, for example, a Benol resin, an acrylic resin, or a phenol resin.

The resin is not particularly limited, as long as it has properties similar to those of the resins above. The copper particle may be spherical or in any other shape such as flake. Thus, the copper paste is not limited to those described above.

The reducing agent is, for example, alcohols having one or more reductive hydroxyl groups in the molecule and having a boiling point of 200° C. or lower, such as ethanol or ethylene glycol. In the present embodiment, two kinds of reducing agents, ethanol (Kanto Kagaku Co., Inc., EL grade) and ethylene glycol (Wako Pure Chemical Industries Co., Ltd., analytical grade) are used. In addition to these compounds, anisole generating alcohol by thermal decomposition is also used as the reducing agent in the baking step described below. The reducing agent is not particularly limited to these compounds described above.

The formulation of the conductive copper paste having such a composition is shown below. The conductive copper pastes (P1) to (P7) in the following Formulations 1 to 7 are examples of the present embodiment, and the present invention is not limited to the Formulations below.

### (Formulation 1) Conductive Copper Paste (P1)

The conductive copper paste (P1) is prepared by adding ethanol as a reducing agent in an amount of 0.34 mass % to a copper paste and stirring the mixture.

### (Formulation 2) Conductive Copper Paste (P2)

The conductive copper paste (P2) is prepared by adding ethanol as a reducing agent in an amount of 0.69 mass % to a copper paste and stirring the mixture.

### (Formulation 3) Conductive Copper Paste (P3)

The conductive copper paste (P3) is prepared by adding ethanol as a reducing agent in an amount of 2.6 mass % to a copper paste and stirring the mixture.

### (Formulation 4) Conductive Copper Paste (P4)

The conductive copper paste (P4) is prepared by adding ethylene glycol as a reducing agent in an amount of 1.8 mass % to a copper paste and stirring the mixture.

### (Formulation 5) Conductive Copper Paste (P5)

The conductive copper paste (P5) is prepared by adding ethylene glycol as a reducing agent in an amount of 2.5 mass % to a copper paste and stirring the mixture.

### (Formulation 6) Conductive Copper Paste (P6)

The conductive copper paste (P6) is prepared by adding ethylene glycol as a reducing agent in an amount of 5.9 mass % to a copper paste and stirring the mixture.

### (Formulation 7) Conductive Copper Paste (P7)

The conductive copper paste (P7) is prepared by adding anisole as a reducing agent in an amount of 1.3 mass % to a copper paste and stirring the mixture.

For comparison with the seven kinds of conductive copper pastes prepared in the present embodiment, a conductive copper paste (P8) (Comparative Example 1) and a conductive copper paste (P9) (Comparative Example 2) are prepared.

### Comparative Example 1

### Conductive Copper Paste (P8)

No reducing agent is added to the copper paste.

### Comparative Example 2

### Conductive Copper Paste (P9)

The conductive copper paste P9 is prepared by adding ethylene glycol as a reducing agent in an excessively large amount (11.3 mass %) to the copper paste and stirring the mixture.

Hereinafter, as a method of using the conductive copper paste, a method of forming a conductive metal paste film (hereinafter “metal film”) by using each of the conductive copper pastes (P1) to (P9) prepared by the Formulations above will be described.

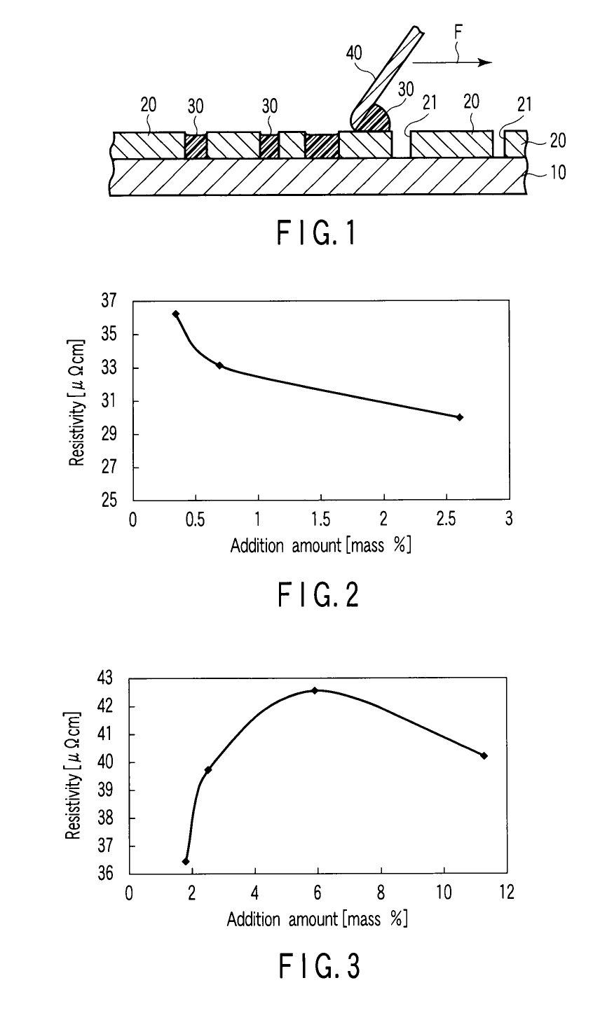

FIG. 1 is an explanatory view schematically illustrating a method of forming a metal film by using a conductive copper paste 30. In FIG. 1, F represents the coating direction of the conductive copper paste 30. The method of forming a metal film will be described below, by taking screen printing as an example.

First, in the substrate installation step, for example, the conductive copper paste 30 is prepared by blending, and then, a screen plate 20 is placed on a substrate 10 formed of a silicon wafer having a thermal oxidation layer. The screen plate 20 has grooves 21 in a pattern of the metal film desirably formed on the substrate 10. The pattern is formed, for example, in the shape corresponding to the shape of the electrodes or wiring of an electronic device. The thickness of the metal film can be controlled by adjusting the depth of the groove 21 or the height of the screen plate 20.

Subsequently in the coating step, the conductive copper paste 30 is coated through the screen plate 20 on the substrate 10. Thus, the conductive copper paste 30 is coated on the substrate 10 by penetration through the grooves 21 formed on the screen plate 20. It is necessary then to coat the substrate 10 with the conductive copper paste 30 uniformly by making it penetrate through the grooves 21 uniformly. For example, the conductive copper paste 30 may be left disconnected from the substrate 10, if the conductive copper paste 30 does not penetrate uniformly.

Thus, the conductive copper paste 30 is coated uniformly on the screen plate 20 and the conductive copper paste 30 is scraped in the coating direction F, for example with a squeegee 40. In this way, the conductive copper paste 30 penetrates reliably through the grooves 21, thereby coating the substrate 10 with the conductive copper paste 30. The conductive copper paste 30 is thus transferred onto the substrate 10.

After application of the conductive copper paste 30 on the substrate 10, the screen plate 20 is separated from the substrate 10. Thus, only the coated conductive copper paste 30 in the shape of the grooves 21 is left on the substrate 10.

Then in the baking step, the conductive copper paste 30 is subjected to heat treatment. First, the substrate 10 carrying the deposited conductive copper paste 30 is placed in a heating apparatus such as oven. Then after placement of the substrate 10, the gas in the oven is substituted with an inert gas such as nitrogen. It is because heat treatment of the conductive copper paste 30 into a metal film in an environment containing oxygen may lead to oxidation of the copper particles contained in the conductive copper paste 30, i.e., formation of an oxidized film on the surface of the metal particles. The oxidized film formed on the metal particle surface leads to deterioration in the conductivity of the formed metal film, i.e., increase in volumetric resistivity. For this reason, substitution of the gas in the oven with nitrogen prevents oxidation of the copper particles. In addition, a reductive reaction of removing the oxide film formed on the metal particles may be carried out more aggressively in the oven before the baking step. The environment in the oven may an environment preventing oxidation or allowing progress of reductive reaction.

After substitution with nitrogen, the oven is heated from room temperature to 200° C., for example, at a heating rate of 10° C. per minute. After heating, the substrate 10 is heated under the temperature condition of 200° C. for 30 minutes, for evaporating the organic solvent therein and baking the metal film. The oxidized metal in the conductive copper paste 30 is reduced by reaction with the reducing agent.

In the description above, the baking step has been carried out, for example, at 200° C., but may be carried out as needed, for example, in the temperature range of 180 to 250° C. In the description above, the solvent has had a boiling point of 200° C. or lower, but ethanol has a boiling point of approximately 78.45° C.; ethylene glycol, a boiling point of approximately 197.30° C.; and anisole, a boiling point of approximately 154° C., and these solvent are different in boiling point from each other. Thus in the baking step, it is necessary to determine an optimal baking temperature according to the kind of the reducing agent used. However, the reducing agent has the maximum boiling point of 200° C., and thus, vaporization of the reducing agent remaining unreacted on the metal surface is prevented at a baking temperature of 250° C. or lower.

Each of the conductive copper pastes 30 (P1) to (P9) coated on the substrate 10 is baked into a metal film in the coating step described above.

After formation of the metal film as described above, the volumetric resistivity of the formed metal film is determined and the values of volumetric resistivity of the conductive copper pastes 30 in respective compositions described above are compared. First, the thickness of the metal film formed on the substrate 10 is determined three times by using a needle-contact profilometer, and the average film thickness is calculated. Then, the surface resistivity of the metal film is determined three times for example by a four-electrode method, to calculate the average surface film resistance. The volumetric resistivity of the metal film is calculated from the values of the film thickness and the surface resistivity. The averaging by measurement for three times removes fluctuation of the measured values due to measuring condition, approximating the measure values to the accurate value.

The average volumetric resistivity thus determined of each metal film formed by using each of the conductive copper pastes (P1) to (P9) is shown below.

### (Formulation 1) Conductive Copper Paste (P1)

The average volumetric resistivity of the metal film formed by using the conductive copper paste (P1) containing ethanol in an amount of 0.34 mass % was 36 μΩ-cm.

### (Formulation 2) Conductive Copper Paste (P2)

The average volumetric resistivity of the metal film formed by using the conductive copper paste (P2) containing ethanol in an amount of 0.69 mass % was 33 μΩ-cm.

### (Formulation 3) Conductive Copper Paste (P3)

The average volumetric resistivity of the metal film formed by using the conductive copper paste (P3) containing ethanol in an amount of 2.6 mass % was 30 μΩ-cm.

### (Formulation 4) Conductive Copper Paste (P4)

The average volumetric resistivity of the metal film formed by using the conductive copper paste (P4) containing ethylene glycol in an amount of 1.8 mass % was 36 μΩ-cm.

### (Formulation 5) Conductive Copper Paste (P5)

The average volumetric resistivity of the metal film formed by using the conductive copper paste (P5) containing ethylene glycol in an amount of 2.5 mass % was 40 μΩ-cm.

### (Formulation 6) Conductive Copper Paste (P6)

The average volumetric resistivity of the metal film formed by using the conductive copper paste (P6) containing ethylene glycol in an amount of 5.9 mass % was 43 μΩ-cm.

### (Formulation 7) Conductive Copper Paste (P7)

The average volumetric resistivity of the metal film formed by using the conductive copper paste (P7) containing anisole in an amount of 1.3 mass % was 35 μΩ-cm.

### Comparative Example 1

### Conductive Copper Paste (P8)

The average volumetric resistivity of the metal film formed as a Comparative Example by using the conductive copper paste (P8) containing no reducing agent was 42 μΩ-cm.

### Comparative Example 2

### Conductive Copper Paste (P9)

The average volumetric resistivity of the metal film formed as a Comparative Example by using the conductive copper paste (P9) containing ethylene glycol in a large excessive amount (11.3 mass %) was 40 μΩ-cm. However, the conductive copper paste (P9) gave no uniform metal film, because part of ethylene glycol was separated after blending.

These conductive copper pastes are metal films for use in electronic devices. Thus, these metal films are subjected to a heat resistance test for examining thermal deterioration in properties caused, for example, by the heat during heat application after the casting step and generated by voltage application to the metal film during use in final products. The heat resistance test is a test for examining increase in volumetric resistivity and presence or absence of breakdown of the metal film when, for example, heat at 250° C., which is possible under use condition, is applied to the metal film. The temperature range during heat application in the heat resistance test may be altered according to the test condition, as long as the temperature satisfies the maximum temperature when the metal film is used actually in its final product.

When heat at 250° C. was applied to the metal film prepared by coating of the conductive copper paste (P5) (Formulation 5) described above in such a heat resistance test, the increase in volumetric resistivity was 29% or less. In contrast, when the metal film prepared by coating with the copper paste manufactured by Daiken Chemical Co., Ltd. without addition of a reducing agent was analyzed in the same heat resistance test, for example, the conductive copper paste (P8) described above showed an increase in resistivity of 34% at 230° C. Thus, addition of a reducing agent is effective in reducing the increase in volumetric resistivity by heat application and improving the heat resistance.

Then, addition amounts of respective reducing agents are compared. FIG. 2 is a graph showing the relationship between the addition amount of ethanol and the average volumetric resistivity, while FIG. 3 is a graph showing the relationship between the addition amount of ethylene glycol and the average volumetric resistivity.

As shown in FIG. 2, increase in the amount of ethanol added from 0.34 mass % leads to decrease in average volumetric resistivity. However, addition of ethanol in an amount of more than 2.6 mass % results in decrease in viscosity of the conductive copper paste and prohibition of favorable agitation. In addition, it also makes it difficult to form a metal film pattern when coating the substrate 10 with the conductive copper paste 30. For this reason, it is difficult to form a pattern, even when the volumetric resistivity is lower, and thus, it is difficult to use a conductive copper paste lower in viscosity.

As shown in FIG. 3, increase in the addition amount of ethylene glycol upward from 1.8 mass % leads to increase in average volumetric resistivity, until the addition amount reaches about 5.9 mass %. However, as shown in the Figure, the average volumetric resistivity is lower at an addition amount of 11.3 mass %. This is because addition of ethylene glycol in a certain amount or more leads to decrease in viscosity of the conductive copper paste, similarly to ethanol. Thus, the average volumetric resistivity when ethylene glycol is added in an amount of 11.3 mass % is not accurate. In addition, similarly to ethanol, ethylene glycol makes pattern forming and thus application difficult because of its low viscosity, even though the average volumetric resistivity is lower.

However, the decrease in viscosity occurs only in the condition above, and there are cases where no decrease in viscosity occurs even when the addition amount is the same, depending on the composition of the metal paste, reducing agent, organic solvent, and others used. Thus, it is necessary to determine the optimal addition amount of the reducing agent appropriately, according to the components, blending rate, actual use condition, constituent materials and others.

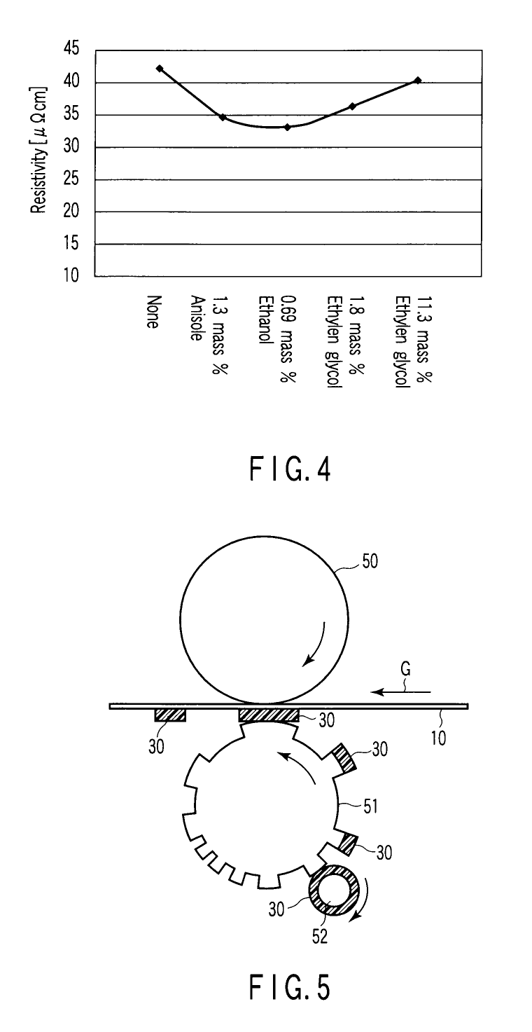

FIG. 4 is a graph showing the relationship between the average volumetric resistivity in each Comparative Example and the kind of the reducing agent used.

As shown in FIG. 4, the average volumetric resistivities of the metal films obtained with the conductive metal paste without any added reducing agent and the conductive metal paste with ethylene glycol added in a large excessive amount in Comparative Examples are compared with those of the conductive metal pastes respectively containing, ethanol, ethylene glycol and anisole as a reducing agent. The Figure shows that the conductive metal pastes with an added reducing agent have an average volumetric resistivity lower than that of the conductive metal paste without any added reducing agent. Similarly, it also shows that the conductive metal paste containing a reducing agent added in a suitable amount has an average volumetric resistivity lower than that of the conductive metal paste containing a reducing agent added in a large excessive amount.

It is thus possible to reduce the volumetric resistivity of the formed metal film reliably by adding an alcoholic reducing agent having one or more reductive hydroxyl groups in the molecule in a suitable amount, even when the conductive metal paste is applied to form a metal film by the coating method. This is because the oxygen molecules in the metal paste are reduced in binding reaction between the oxide in the metal paste and the reductive hydroxyl group in the baking step.

The reducing agent is “added in a suitable amount” as described above, and such a phrase is used because the optimal blending rate of the reducing agent varies according to the composition of the copper paste and others as described above. In the present invention, it is possible to remove the oxygen molecules in the metal paste, i.e., to reduce the oxidized metal paste, by using a reducing agent having one or more reductive hydroxyl groups in the molecule, also in the conductive metal pastes in other configurations.

It is thus possible to reduce the resistivity of the metal film formed with the conductive metal paste, even when a method lower in cost and higher in throughput than a conventional film forming method such as the vacuum film-forming method, is used. It is also possible to reduce production cost, because it also reduces the facility investment cost associated with metal film formation and shortens its processing period.

It is also possible to reduce the resistance of the metal film, even when a conductive metal paste containing copper particles is used, and the method is also applicable to conductive metal pastes containing other metal particles.

As described above, according to the conductive metal paste and the method of forming the same in the present embodiment, it is possible to reduce the volumetric resistivity of the metal film by adding an alcoholic reducing agent having one or more reductive hydroxyl groups in the molecule in a suitable amount. It is also possible to reduce the volumetric resistivity even by the coating method and to reduce the production cost.

It is further possible to lower the heat application temperature in the baking step by using an alcohol having a boiling point of 200° C. or lower and to shorten the processing time and reduce the cost for heating apparatus and others. It is also possible to reduce the metal film efficiently with a reducing agent, by preventing vaporization of the reducing agent remaining unreduced on the metal surface at a baking temperature of 250° C. or lower.

Hereinafter, a modified embodiment will be described. For example, although screen printing has been used in the embodiment described above, a letterpress printing method may be used instead. As shown in FIG. 5, in the letterpress printing, a substrate 10 to be printed is held between an impression cylinder roller 50 and a printing cylinder roller 51. An ink roller 52 is brought into contact with the printing pattern on the printing cylinder roller 51, while the impression cylinder roller 50 and the printing cylinder roller 51 are rotated to feed the substrate 10 in the direction G indicated by an arrow in FIG. 5. The ink roller 52, which carries the conductive copper paste 30 thereon, automatically applies the conductive copper paste 30 on the substrate 10 by bringing the ink roller 52 into contact with the printing pattern on the printing cylinder roller 51. It is possible to automate coating of the conductive copper paste 30 by such letterpress printing. The letterpress printing may also be replaced with other printing methods.

Although a copper paste has been used in the embodiment described above, other metal pastes are also applicable. In addition, as described above, the reducing agent according to the present invention is applicable in a composition other than those described above.

The present invention is not limited to the embodiments above, and various modifications in its constituent elements are possible within the scope of the present invention in operational phases. In addition, various inventions can be made additionally, simply by suitable combination of the multiple components disclosed in the embodiments above. For example, some of the components may be eliminated from all the components shown in the embodiments. Further, components in different embodiments may be combined with each other properly.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A conductive metal paste, comprising:
metal particles dispersed as a conductive medium in a thermosetting resin composition;
an organic solvent contained in the thermosetting resin composition; and
an alcoholic reducing agent which is contained in the thermosetting resin composition, has at least one reductive hydroxyl group in a molecule and a boiling point of 200° C. or lower, and reduces oxidized metal particles.

2. A conductive metal paste, comprising:
metal particles dispersed as a conductive medium in a thermosetting resin composition;
an organic solvent contained in the thermosetting resin composition; and
anisole contained in the thermosetting resin composition as a reducing agent which reduces oxidized metal particles.

3. A method of forming a metal film, comprising:
coating a conductive metal paste containing metal particles dispersed as a conductive medium in a thermosetting resin composition, an organic solvent contained in the thermosetting resin composition, and a reducing agent contained in the thermosetting resin structure for reduction of oxidized metal particles; and
baking the coated conductive metal paste by applying heat at 180° C. or higher and 250° C. or lower into a metal film.

4. The method of forming a metal film according to claim 3, wherein the reducing agent is an alcohol having at least one reductive hydroxyl group in a molecule and having a boiling point of 200° C. or lower.

5. The method of forming a metal film according to claim 4, wherein the metal film is baked under an atmosphere suppressing oxidation reaction and facilitating reductive reaction while heat is applied to the conductive metal paste.

6. The method of forming a metal film according to claim 3, wherein the reducing agent is anisole.

7. The method of forming a metal film according to claim 6, wherein the metal film is baked under an atmosphere suppressing oxidation reaction and facilitating reductive reaction while heat is applied to the conductive metal paste.
